(19) United States
(12) Patent Application Publication
(10) Pub. No.: US 2011/0071817 A1
(43) Pub. Date: Mar. 24, 2011

(54) System and Method for Language Identification

(76) Inventor: Vesa Siivola, Erie, CO (US)

(21) Appl. No.: 12/888,998

(22) Filed: Sep. 23, 2010

Related U.S. Application Data
(60) Provisional application No. 61/245,345, filed on Sep. 24, 2009.

(51) Int. Cl. G06F 17/20

(52) U.S. Cl. 704/8

(57) ABSTRACT

A system and method for training a language classifier are disclosed that may include obtaining an initial dictionary-based classifier model, stored in a computer memory, the model including a plurality of classifier n-grams; pruning away selected ones of the n-grams that do not significantly affect a performance of the classifier model; adding, to the model, selected supplemental n-grams that increase the effectiveness of the classifier model at identifying a language of a text sample, thereby growing the classifier model; and enabling the adding step to include adding n-grams of varying order, thereby enabling the provision of a variable-order model.

### CROSS-REFERENCE TO RELATED APPLICATIONS

This application claims the benefit of U.S. Provisional Patent Application Ser. No. 61/245,345, filed Sep. 24, 2009, entitled “Language Identification For Text Chats”, the entire disclosure of which is hereby incorporated herein by reference.

### BACKGROUND OF THE INVENTION

The present invention relates in general to language instruction and in particular to language identification based on a sample language input.

The problem of automatic language identification for written text has been extensively researched. The corpus of messages from a text chat for language learning poses challenges for language identification. The messages may be short, ungrammatical, and may contain spelling errors. The messages may contain words from different languages, and the script of the language may be romanized in different ways. The foregoing factors may make straightforward comparisons to known text templates unhelpful. Herein, the term “n-gram” refers to a sequence of “n” text items from a given sentence. The items can be phonemes, syllables, letters or words, depending on the application.

Prior research has demonstrated that the probability distribution of character 2-grams is different for all languages, and can be used within a language classifier to identify the language of a text message. Other research suggests that for each language, a list of n-grams seen in the training set for all orders up to a given order be constructed (the full list of order 5 would contain 1-grams, 2-grams, . . . , 5-grams). The list is then ranked by frequency of appearance, with the procedure being repeated for all of the languages of interest.

The text of an unknown language is processed in the same manner as described above for the language classifier, and the ranking of the n-grams is compared to the trained lists in the classifier. Then, the list with the most matches is selected as the recognized language. One existing approach calculates the probabilities of all trigrams that have appeared more than 100 times in the training set, and uses this as a basis for determining which language a document of previously unknown language is written in.

This existing approach also shows that short words such as conjunctions can be used for language identification. Similarly, further research has used character n-grams as search terms for information retrieval. Teahan used Prediction by Partial Match to create character-based Markov models for several languages. The cross-entropy between the unknown text and all models is calculated. The language model that demonstrating the highest probability (lowest cross-entropy) of correspondence to the unknown text is identified as the language of the unknown text.

### SUMMARY OF THE INVENTION

In accordance with one aspect of the present invention, a method is directed to Classifying the language of typed messages in a text chat system used by language learners. This document discloses a method for training a language classifier, where “training the classifier” generally corresponds to improving the classifier by selectively adding and selectively removing text entries to improve the performance and/or data storage efficiency of the classifier. A dictionary-based method may be used to produce an initial classification of the messages. From that starting point, full-character-based n-gram models of order 3 and 5, for example, may be built. A method for selectively choosing the n-grams to be modeled may be used to train high-order n-gram models. One embodiment of this method may generate models for 57 languages and can obtain over 95% accuracy on the classification of messages that are unambiguously in one language. Compared to the best 5-gram based classifier, the number of classification errors is reduced by 21% while the model size is reduced by 93%.

According to one aspect, the invention is directed to a machine-implemented method for training a language classifier, that may include the steps of obtaining an initial dictionary based classifier model, stored in a computer memory, the model including a plurality of classifier n-grams; pruning away selected ones of the n-grams that do not significantly affect a performance of the classifier model; adding, to the model, selected supplemental n-grams that increase the effectiveness of the classifier model at identifying a language of a text sample, thereby growing the classifier model; and enabling the adding step to include adding n-grams of varying order, thereby enabling the provision of a variable-order model.

Preferably, the method further includes training the classifier model with interpolated modified Kneser-Ney smoothing, although other smoothing methods that are know in the art may be used as well. Preferably, the method further includes modeling only a subset of the n-grams prior to the pruning step. Preferably, the adding step includes using Kneser-Ney growing. Preferably, the pruning step includes using Kneser pruning. Preferably, the method further includes establishing a maximum order of the n-grams at a fixed value.

According to another aspect, the invention is directed to a machine-implemented language identification method that may include storing variable-order n-gram language classifiers for a plurality of languages in a computer memory, thereby providing a plurality of respective language classifiers; comparing a text message to each the plurality of classifiers using a processor; determining a match probability score for each of the comparisons; and identifying the language associated with the classifier incurring the highest match probability score as the language of the text message. Preferably, the variable-order n-grams correspond to one of the group consisting of: a variable number of letters; a variable number of phonemes; and a variable number of words.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a bar graph showing the number of text messages in each of plurality of languages included within a labeled set of text message for use in testing in one embodiment of the present invention;

FIG. 2 is a bar chart showing the variation of language classification accuracy as a function of message length in accordance with an embodiment of the present invention;

FIG. 3 includes graphs showing the number of n-grams by order and the n-gram hit rate on the test set for selected models for the variable order classifier. More specifically, FIG. 3A displays the pertinent data for the English language model; FIG. 3B for the French model; and FIG. 3C for the Finnish model. In each of the three graphs, the solid line shows the how the n-grams are distributed between different orders in the model. The dashed line shows which n-gram orders were used when classifying the 5,000 messages of the test data. And, the dotted line shows which n-gram orders were used when classifying the data that was in the same language as the model;

FIG. 4 is a block diagram of an audio hardware that may be used in conjunction with one or more embodiments of the present invention; and

FIG. 5 is a block diagram of a computer system that may be used in conjunction with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

An original n-gram classifier may be constructed from the training data that has been classified by the dictionary-based system. The resulting n-gram model may be grown or pruned. The data may be reclassified with an existing model and a new model may be constructed based on this hopefully more accurately labeled training data. One possible application for a text chat message classification system would be in language learning. For example, a teacher could monitor the distribution of languages used by the students in response to a task assigned thereto, and how much time the students spend on the task.

In an embodiment, the training of the language identification system begins with the production of a labeled set of training samples from the unlabeled data with a dictionary-based classifier. This set of training samples is then used to train the initial n-gram models. The n-gram models are then used to produce a new labeled training set for the next iteration of n-gram training. The iteration is finished when the performance of the classifier no longer increases for the development data set.

Initialization with Dictionaries

It is desirable to create a labeled text corpus, from which the first iteration of character-based n-gram models can be trained. Each message [symbol] ={w₁, . . . , w_{N}} was tested against all of the available dictionaries {d₁, . . . , d_{O}}, and the number of words having matches in dictionaries was recorded. Because there were not dictionaries for all languages and because some of the best known languages (e.g., Chinese, Japanese, Korean) are not based on the Latin alphabet, the ratio of non-ASCII characters Cₙₐ to all characters c in the message text corpus was calculated. The magnitude of this ratio is treated as reflecting the probability that the message was in one of the languages for which no dictionary was available.

The result was scaled to work with the results from the dictionaries. Thus, the condition of all characters being non-ASCII would correspond to having 3 words match the dictionary of a language. The number “3” was determined by quick experimentation, and seems to be a good balance between detecting a ideogram based or syllable-encoded language against a language, where some characters do not belong to the ascii set. There is no highly principled theory behind this, and the use of three words is not mandatory.

The resulting count would be the score s( [symbol] ,dᵢ) for the language l:

$$s ( M , {d}_{l} ) = \{ \begin{matrix}\vert \{ i : {w}_{i} ∈ {d}_{l} \} \vert , & if ∃ {d}_{l} \\ 3 {c}_{na} / c , & otherwise\end{matrix} \qquad ( 1 )$$

When creating the initial labeled data set, we only kept the data that the dictionary-based classifier was confident of. The rest of the data was discarded. The confidence calculation is discussed later herein.

For each message in Russian, Ukrainian or Bulgarian, a romanized version of the same message was added to the training set. However, romanization was not performed for Arabic, Japanese, and Chinese.

Among the methods that can be used for language modeling in speech recognition systems, an interpolated modified Kneser-Ney smoothed n-gram model seems to give the best results. Other methods may match or surpass the effectiveness of the Kneser-Ney method. However, these other methods may require significantly more computational resources. Herein, the full character n-gram models may be trained with interpolated, modified Kneser-Ney smoothing. Herein, the language identifier associated with the n-gram model that yields the highest probability of a match when used to evaluate a particular text message is considered by the method disclosed herein to be the language of the particular text message.

### Variable Order N-Gram Models

In one approach, a full n-gram model stores estimates for the probabilities of all n-grams that are found in the training text up to the given maximum order. One problem with this approach is that the memory consumption of both the training algorithm and the actual model increases almost exponentially with the order of the model.

The problem of excessive memory consumption can be addressed by reducing the size of the model. This size reduction may be achieved by pruning away the n-grams that do not have much effect on the performance of the model. Thus, the memory consumption of the training algorithm can be decreased by choosing to explicitly model only a subset of possible n-grams before selectively removing n-grams deemed to not significantly contribute to the performance of the model.

The growing and pruning methods can be combined in such a manner that they produce variable-order models which have similar smoothing characteristics to the Kneser-Ney smoothing for full models. This is the method that is used in the experiments described in the following. The models produced in this manner are compact and still retain an excellent modeling accuracy.

For training an n-gram model, we wanted only the data for which we thought the classification was likely to be correct. Herein, a heuristic confidence function is used. Let us define the set of all language models Λ=λ₁, . . . , λ_{K}. The message to be classified is denoted by [symbol] and probability given by the best model is denoted P₁=maxᵢP( [symbol] λᵢ). The confidence score C can be calculated from

$$C ( M \vert Λ ) = \frac{{P}_{1}}{{\sum }_{j = 1}^{K} P ( M \vert λ j )} . \qquad ( 2 )$$

For the dictionary-based classifier, we use this confidence function except that the probabilities are replaced by the scores s of the classifier. To clarify a disparity in confidence scores where the best P₁ and second best P₂ entropies are of sufficient magnitude, we can warp the entropy scores from the original P( [symbol] |λᵢ) to P_{warped}( [symbol] |λᵢ).

$${P}_{warped} ( M \vert λ ) = {P ( M \vert λ )}^{- \frac{2 log ( {P}_{1} / {P}_{2} )}{{( log ( {P}_{1} ) / \vert M \vert )}^{s}}} , \qquad ( 3 )$$

where | [symbol] is the number of characters in the message [symbol] Replacing P with P_{warped} in Equation (2) provides desirable results.

Turning to equation (3), the warped form also takes into account the absolute value of the best model.—if no model gives a good score, we shouldn't say that we are certain about the classification even if, relatively speaking, the best model clearly has the best score. Using the warped probabilities for confidence seems to give values that are more intuitive for a human being. In preferred embodiments herein, the warped confidence function is used for the n-gram classifiers.

### Experiments/Data

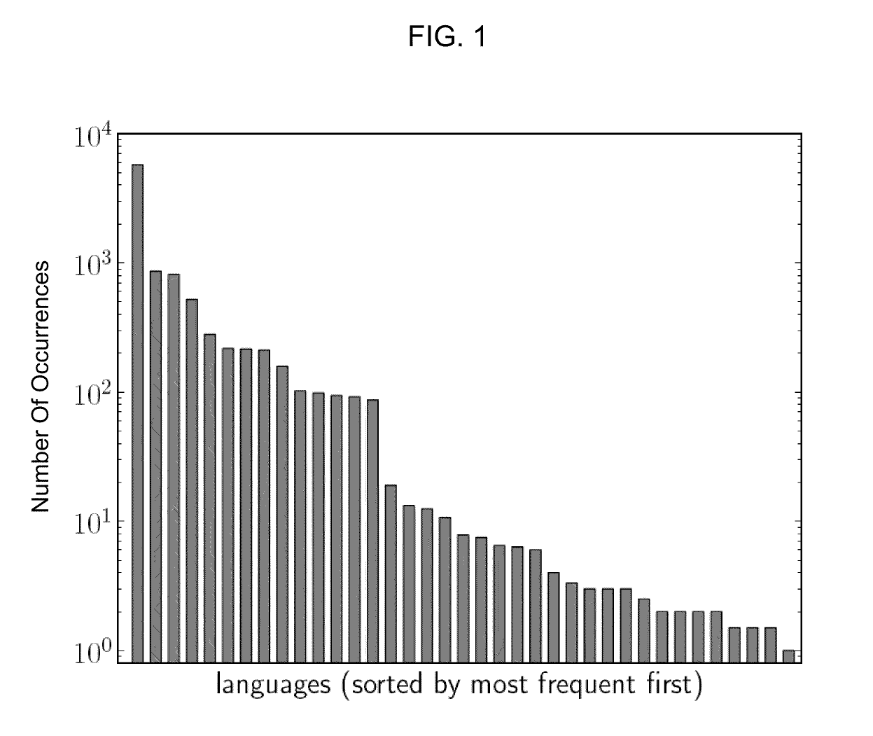

The training data consisted of 120 million chat messages containing 480 million words (2.4 billion characters) collected from a language learning site. The average length of a message is 20 characters. Each participant in the chat had been asked to list the languages he knows. The information provided by the participants was not considered to be completely reliable. Thus, based on the data, we decided to add English as a known language for every user. A separate set of 10,000 messages with 41,000 words (230,000 characters) was labeled by hand and put aside, one half for the development set and the other half for the test set. The development set was used for tuning the parameters of the learning process, and the final tests were run on the test set. The distribution of different languages in the hand-labeled set is shown in FIG. 1. Since the 10,000 hand-labeled samples were randomly picked from the data, we believe that this represents the trend in the full data set also.

Languages that use different character sets (e.g., Cyrillic, Greek, Kanji, Hiragana) were often written in romanized form. The language may change from one message to another or even within one message. All the data was encoded in UTF-8 (8-bit UCS/Unicode Transformation Format). The chat discussions usually involved only a few languages. For this work, each message was considered separately, and no effort was made to model the flow of the discussion. Also, in this embodiment, the classifier tries to match just one language to each message.

For some types of messages it was impossible to determine the language based on the message alone (e.g., messages containing only smileys, URLs, e-mail addresses, proper names, or text sequences representing the sounds of universal utterances such as “umm” or ‘hahahaa’). Other messages were ambiguous in that some languages could be ruled out, but several languages would remain as possible candidates for the language the message was being expressed in such as: “si”, “sto”, “pronto”, “tak”). Some messages contained abbreviations not commonly used in print (e.g., ‘lol’, ‘rotflmao’). Since the users may not be fluent in the language in which they are writing, the text could contain a substantial number of grammatical and spelling errors.

### Training

When training the models, we limited the number of languages against which each message was checked. We calculate the entropies and confidences over the languages that at least one of the participants knew or were learning (i.e. the union of the sets of languages known to the participants). If the classifier output would not be a language known to all participants (intersection of the sets of languages known to the participants), the message would be discarded from the training set of the next round. The message would also be discarded if the confidence of the classifier was not high enough.

In one embodiment, an initial dictionary-based classifier was built on top of Pyenchant (available from www.rfk.id.au/software/pyenchant) which used GNU Aspell (http://aspell.net) to provide the back-end dictionaries This embodiment employs dictionaries for 107 languages. There were a few common languages that were not in this set, including Chinese, Korean and Japanese. If a language was detected to be character-based, limiting the search to the languages that the participants of the discussion knew helped identify the correct language. A set of regular expressions was used to find unclassifiable messages (e.g., URLs, number sequences, smileys) and the results were used to train a “junk” model.

Various embodiments of the character-based n-gram models were trained with the VariKN toolkit. The toolkit is open source software licenses under LGPL, and further information can be found at http://lib.tkk.fi/Diss/2007/isbn9789512288946 and at http://www.cis.hut.fi/vsiivola/is2007less.pdf.

The full models were trained with interpolated modified Kneser-Ney smoothing. A combination of Kneser-Ney growing and revised Kneser pruning was used to create the variable-order models.

We assumed there would be no significant information for language identification above order-15 models. Accordingly, the order-15 limit (meaning a 15-gram limit) was set as the maximum order to limit the required computational effort. The n-gram models were used to produce a new labeled version of the training data that was used to train the next iteration of n-gram models. This was repeated until the performance of the model on the development set no longer improved. If there was a language that had less than 1000 bytes of training data available during any iteration, that language was removed altogether from the rest of the process. After various iterations, 57 models were completed, one of which was a model for messages that were equally fit for all languages (e.g, smileys, number sequences, URLs). The training parameters were tuned by hand on the development data and the best models were tried on the test data.

### Testing

The language classifier was free to choose any of the fifty-seven modeled languages for all of the set of text messages (the “test set”) on which the language identification system and method was to be applied. The test set contained sentences in forty different languages (for the distribution of the hand labeled set, see FIG. 1. We decided to create a test set that would not contain the same number of sentences in all of the modeled languages for two reasons. First, it was considered preferable for the test to include a test set having a distribution of languages that was similar to that likely to be encountered using real world data. Second finding a reasonably large fixed number of sentences for all languages by hand would have been unnecessary and unduly burdensome.

In the test, five classifiers were tried. The Dummy classifier labeled all messages with the most common language of the data—English. The dictionary-based classifier that was used to initially label the data was also tested. In the following, a “tie” corresponds to a situation in which the language identification scoring technique generates identical scores for different languages. In this embodiment of the classifier, ties involving English were resolved in favor of English as the identified language. Ties between two or more languages, not including English, were resolved arbitrarily. Though the dictionary-based classifier was able to establish any dictionary-supported language as the language of a sample text message, the classifier lacked the ability to identify the languages of messages for which the classifier did not have a dictionary.

The tested n-gram classifiers were full 3-gram, full 5-gram, and variable-order classifiers. In the test data, four different kinds of messages were found. For unambiguous messages, the message was clearly in one language (86.4% of test data). “Junk data” (7.9% of test data) would fit any language equally well or badly (e.g., numbers, URLs, smileys etc). Ambiguous messages could be valid in many languages (4.4% of test data). Multilingual messages contained words in two or more different languages (1.3% of training data).

TABLE 1
CLASSIFICATION RESULTS: (M = million)

| | | Correct % | |
|---|---|---|---|
| 2 * Classifier | 2 * num n-grams | All msgs | Unambig. msgs |
| Dummy | NA | 63.2 | 66.8 |
| Dictionary | NA | 78.2 | 78.5 |
| Full 3-g | 5.5M | 88.2 | 88.7 |
| Full 5-g | 31.7M | 92.8 | 94.2 |
| Variable-g | 2.4M | 93.9 | 95.4 |

For unambiguous messages (referred to as “Unambig. msgs” in Table 1), messages that were multilingual, ambiguous or junk (all of which designations are described above) were removed from the test. The results for unambiguous data are clear: i.e. the classification result is either correct or incorrect. For ambiguous and multilingual data, the classification was counted as correct if it matched any of the possible languages. The results shown given in Table 1.

The variable-order model gave the best results, 21% reduction in the number of errors for unambiguous messages in comparison with the 5-g model, and a 93% reduction in model size in comparison with the 5-gram model. It is possible that the categories named “ambiguous” and “multilingual” have some overlap, but in our test data, the sentences were hand labeled to either one or the other category.

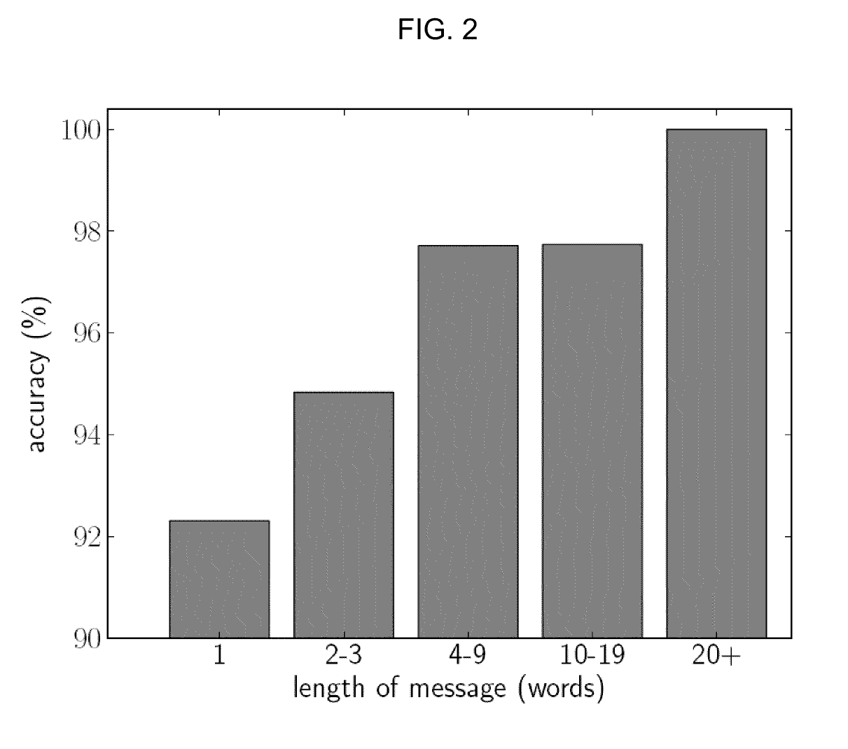

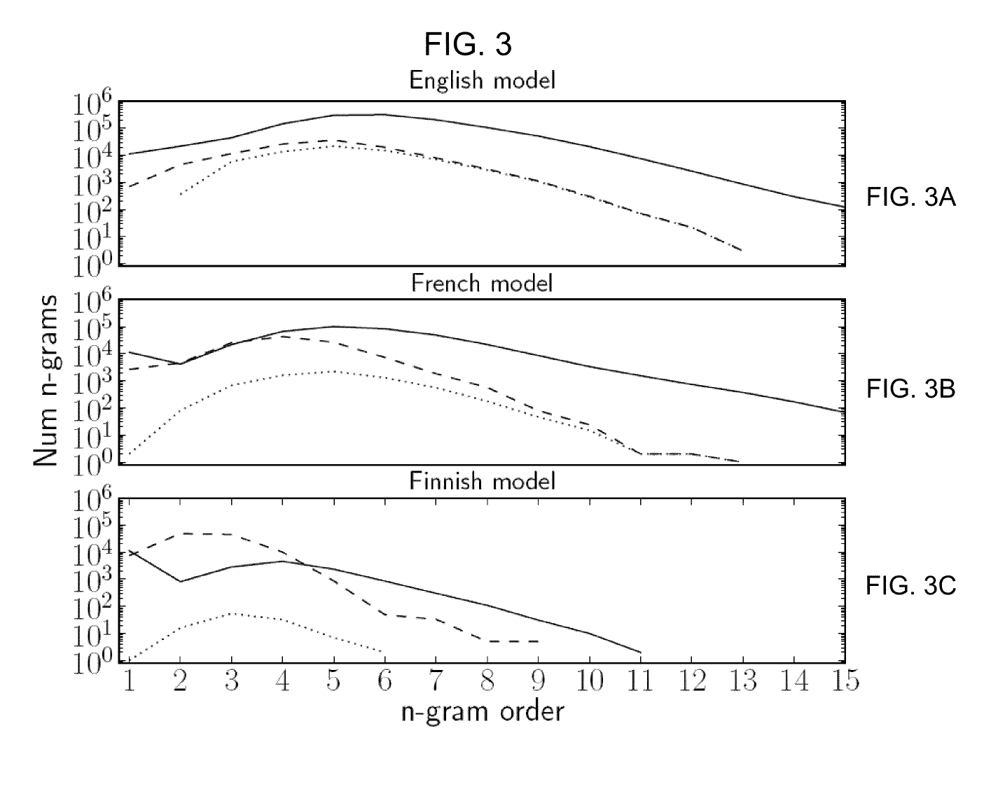

FIG. 2 shows how the length of the message affects the classification accuracy. For variable order models, FIG. 3 shows how n-grams are distributed between different orders and which n-gram orders are used during the classification.

### Discussion

The most common language of the messages was English, as shown by the performance of the dummy classifier. The n-gram based approaches clearly generate better results than the dictionary-based approach. The variable-order models form a compact and more accurate classifier than the fixed-order models. It is likely that there are two reasons for this.

First, the variable-order model can take into account arbitrary long character sequences and there seems to be some useful information in classifier entries that extend beyond the 5-grams. Second, the model is constrained to learn only the essential features of the data. This means that all the n-grams that are not typical for the language are dropped, resulting in a model that is more robust against classification errors of the training data. The parameters of the training procedure (such as the confidence threshold, variable-order growing, and pruning parameters) could be further optimized to make the classifier more effective. In this embodiment, the parameters were hand tuned with a help of a few experiments on the development set.

An obstacle was detected in training the classifier to learn Romanized forms of languages for which there were not explicitly Romanized training data for. However, an alternative embodiment may train romanized forms of the languages implicitly by lowering the confidence threshold for accepting the classification into the training data of the next round of iteration.

In this alternative embodiment, the confidence threshold for languages lacking a Romanized form may be selectively lowered. Another way of improving the classifier performance would be to augment the training data with text of a known language. In preliminary tests we tried using text corpora, which happened to be for languages that already seemed well modeled by the classifier. The use of the text corpora improved the performance of the classifier. Augmenting the training data with romanized text of the languages for which Romanization utility is not available should further improve the performance of the classifier.

### CONCLUSION

The above describes a high-accuracy language identification system for text chat messages from unlabeled data. In one embodiment, initial labeling was created based on the knowledge of the languages that the participants of the chat had fluency in, and dictionaries were used to choose between the possible languages. The final classifier was based on character n-grams. We found that controlling the number of parameters of the n-gram model through a combination of growing and pruning methods provided a compact model with excellent accuracy. Including more information about possible romanizations of languages written in non-Latin scripts tends to further improve the accuracy of the classifier.

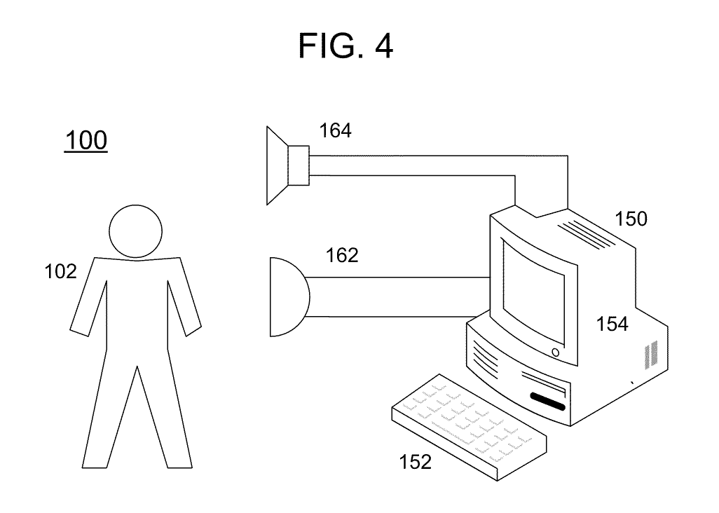

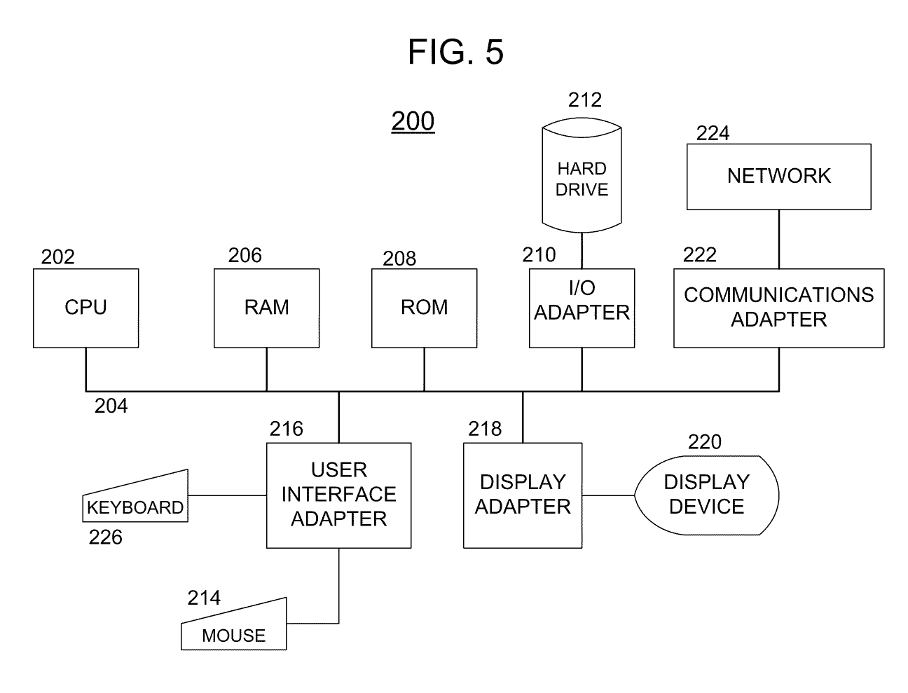

FIGS. 4 and 5 illustrate equipment that may be used in conjunction with one or more embodiments of the present invention.

FIG. 4 is a schematic block diagram of a learning environment 100 including a computer system 150 and audio equipment suitable for teaching a target language to student 102 in accordance with an embodiment of the present invention. Learning environment 100 may include student 102, computer system 150, which may include keyboard 152 (which may have a mouse or other graphical user-input mechanism embedded therein) and/or display 154, microphone 162 and/or speaker 164. The computer 150 and audio equipment shown in FIG. 1 are intended to illustrate one way of implementing an embodiment of the present invention. Specifically, computer 150 (which may also referred to as “computer system 150”) and audio devices 162, 164 preferably enable two-way audio-visual communication between the student 102 (which may be a single person) and the computer system 150.

In one embodiment, software for enabling computer system 150 to interact with student 102 may be stored on volatile or non-volatile memory within computer 150. However, in other embodiments, software and/or data for enabling computer 150 may be accessed over a local area network (LAN) and/or a wide area network (WAN), such as the Internet. In some embodiments, a combination of the foregoing approaches may be employed. Moreover, embodiments of the present invention may be implemented using equipment other than that shown in FIG. 1. Computers embodied in various modern devices, both portable and fixed, may be employed including but not limited to Personal Digital Assistants (PDAs), cell phones, among other devices.

FIG. 5 is a block diagram of a computing system 200 adaptable for use with one or more embodiments of the present invention. Central processing unit (CPU) 202 may be coupled to bus 204. In addition, bus 204 may be coupled to random access memory (RAM) 206, read only memory (ROM) 208, input/output (I/O) adapter 210, communications adapter 222, user interface adapter 206, and display adapter 218.

In an embodiment, RAM 206 and/or ROM 208 may hold user data, system data, and/or programs. I/O adapter 210 may connect storage devices, such as hard drive 212, a CD-ROM (not shown), or other mass storage device to computing system 200. Communications adapter 222 may couple computing system 200 to a local, wide-area, or global network 224. User interface adapter 216 may couple user input devices, such as keyboard 226, scanner 228 and/or pointing device 214, to computing system 200. Moreover, display adapter 218 may be driven by CPU 202 to control the display on display device 220. CPU 202 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A machine-implemented method for training a language classifier, the method comprising the steps of:
obtaining an initial dictionary-based classifier model, stored in a computer memory, the model including a plurality of classifier n-grams;
pruning away selected ones of the n-grams that do not significantly affect a performance of the classifier model;
adding, to the model, selected supplemental n-grams that increase the effectiveness of the classifier model at identifying a language of a text sample, thereby growing the classifier model; and
enabling the adding step to include adding n-grams of varying order, thereby enabling the provision of a variable-order model.

2. The method of claim 1 further comprising the step of:
training the classifier model with interpolated modified Kneser-Ney smoothing.

3. The method of claim 1 further comprising the step of:
modeling only a subset of the n-grams prior to the pruning step.

4. The method of claim 1 wherein the adding step comprises:
using Kneser-Ney growing.

5. The method of claim 1 wherein the pruning step comprises:
using Kneser pruning.

6. The method of claim 1 further comprising the step of:
establishing a maximum order of the n-grams at a fixed value.

7. The method of claim 1 further comprising the step of:
repeating the pruning and adding steps.

8. A machine-implemented language identification method comprising:
storing variable-order n-gram language classifiers for a plurality of languages in a computer memory, thereby providing a plurality of respective language classifiers;
comparing a text message to each the plurality of classifiers using a processor;
determining a match probability score for each of the comparisons; and
identifying the language associated with the classifier incurring the highest match probability score as the language of the text message.

9. The method of claim 8 wherein the variable-order n-grams correspond to one of the group consisting of: a variable number of letters; a variable number of phonemes; and a variable number of words.
